(19) United States
(12) Patent Application Publication
(10) Pub. No.: US 2006/0136834 A1
(43) Pub. Date: Jun. 22, 2006

(54) Scrollable toolbar with tool tip on small screens

(76) Inventors: Jiangen Cao, Dublin, CA (US); Yingfeng Su, Sunnyvale, CA (US)

Correspondence Address: PATENT LAW GROUP LLP, 2635 NORTH FIRST STREET, SUITE 223, SAN JOSE, CA, 95134, US

(21) Appl. No.: 11/014,505

(22) Filed: Dec. 15, 2004

(51) Int. Cl. G06F 17/00; G06F 3/00; G06F 9/00

(52) U.S. Cl. 715/779

(57) ABSTRACT

A toolbar includes a first toolbar area and a second toolbar area. The first toolbar area includes a plurality of icons and a cursor visually identifying one of the icons. When a user moves the cursor beyond a position, the icons shift so that at least one of the icons is removed and at least one new icon is added. The second toolbar area includes information about the icon identified by the cursor.

### FIELD OF INVENTION

This invention relates to a user interface, and specifically to a toolbar for a small screens.

### DESCRIPTION OF RELATED ART

When running a feature-rich application on a device with limited screen real estate, the design of an easy-to-use toolbar with many buttons is not trivial. Furthermore, as the buttons are small, their graphical designs may not suggest their functions. Thus, what is needed is a toolbar that addresses these challenges.

### BRIEF DESCRIPTION OF THE DRAWINGS

FIG. 1 illustrates a user interface with a scrollable toolbar in one embodiment of the invention.

FIGS. 2, 3, and 4 illustrate a first type of scrollable toolbar in one embodiment of the invention.

FIG. 5 illustrates a second type of scrollable toolbar in one embodiment of the invention.

FIG. 6 illustrates a third type of scrollable toolbar in one embodiment of the invention.

Use of the same reference numbers in different figures indicates similar or identical elements.

### SUMMARY

A toolbar includes a first toolbar area and a second toolbar area. The first toolbar area includes a plurality of icons and a cursor visually identifying one of the icons. When a user moves the cursor beyond a position, the icons shift so that at least one of the icons is removed and at least one new icon is added. The second toolbar area includes information about the icon identified by the cursor.

### DETAILED DESCRIPTION

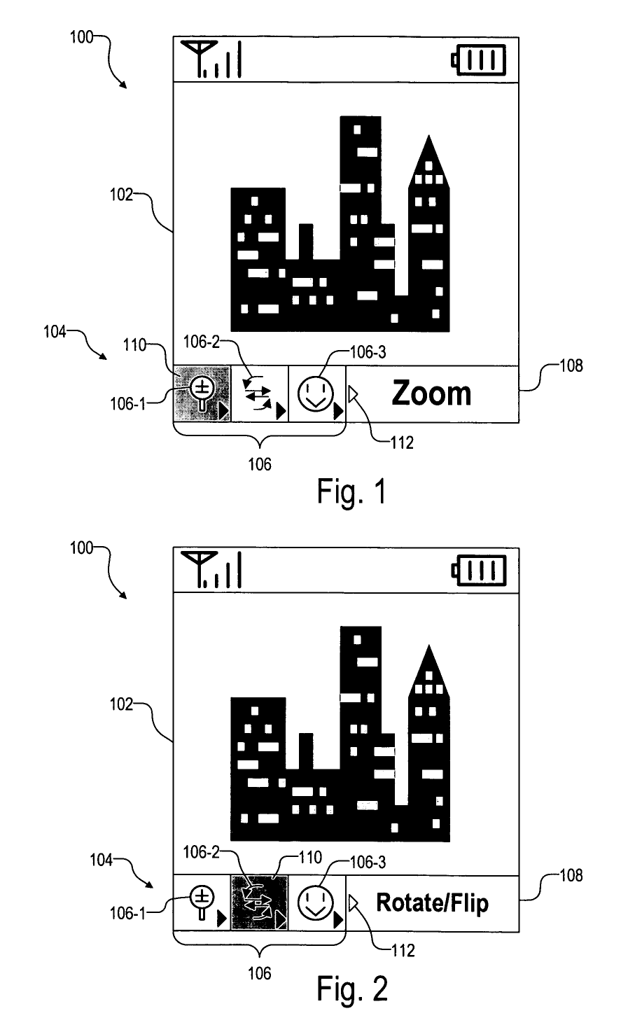

FIG. 1 illustrates a user interface 100 for a device having a small screen in one embodiment of the invention. Although a small screen may be less than 200 pixels wide, user interface 100 may be adopted for devices having larger screens. The device may be a cell phone, a portable data assistant (PDA), a portable media player (PMP), or other similar devices. Although not shown, the device would have input keys for interacting with the device.

User interface 100 includes a display area 102 and a tool bar 104. Display area 102 is used to display media, such as text, image, and video. Toolbar 104 includes a first toolbar area 106 and a second toolbar area 108. Toolbar area 106 displays tool icons and a cursor 110 for identifying one of the tool icons. Cursor 110 can be a highlighted box that the user moves over the tool icons to select a tool icon. Toolbar area 108 displays information about the tool icon identified by cursor 110. The information may be a tip (e.g., the name of the tool) for the identified tool icon.

Although toolbar 104 contains many tools, less than all of the tool icons are displayed at once to the user in order to conserve space on the screen. An indicator 112 visually tells the user that toolbar 104 has additional tools to the right of the current tool icons. In one embodiment, toolbar area 106 only displays three tool icons 106-1, 106-2, and 106-3 (e.g., icons for zoom, rotate/flip, and a photo workshop). Any of the tool icons may have a black triangle icon to indicate the selection of that tool icon will lead to another tool bar instead of an immediate operation. When cursor 110 reaches a set position, the currently displayed tool icons shift so that at least one tool icon is removed and at least one new tool icon is added to toolbar area 106. Thus, the user can scroll through toolbar 104. The tool icons can scroll in several ways described hereafter.

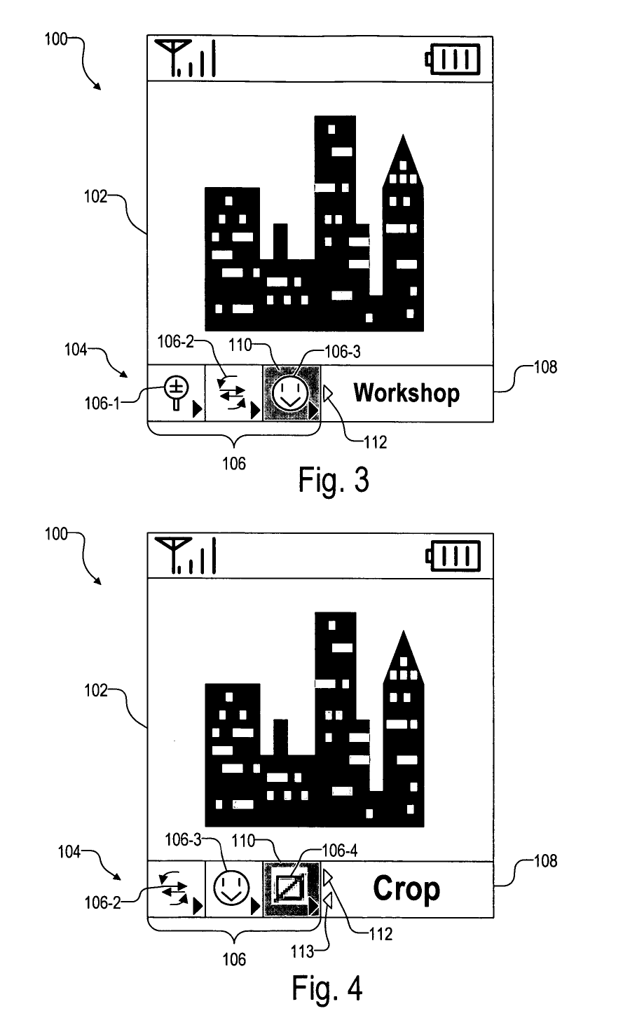

In one embodiment illustrated in FIGS. 2 to 4, tool icons 106-1, 106-2, and 106-3 remain stationary while cursor 110 moves over them. When cursor 110 moves beyond the right-most or the left-most tool icon, tool icons 106-1, 106-2, and 106-3 shift away from the direction cursor 110 is moving so that one of the previously displayed tool icons is removed and a new tool icon is added to toolbar area 106. For example, when cursor 110 moves to the right beyond tool icon 106-3, tool icons 106-1, 106-2, and 106-3 shift to the left so that tool icon 106-1 is removed and a new tool icon 106-4 is added to toolbar area 106. Note that cursor 110 now identifies tool icon 106-4. Further note that in FIG. 4, indicators 112 and 113 visually tell the user that toolbar 104 has additional tools to the right and left of the current tool icons.

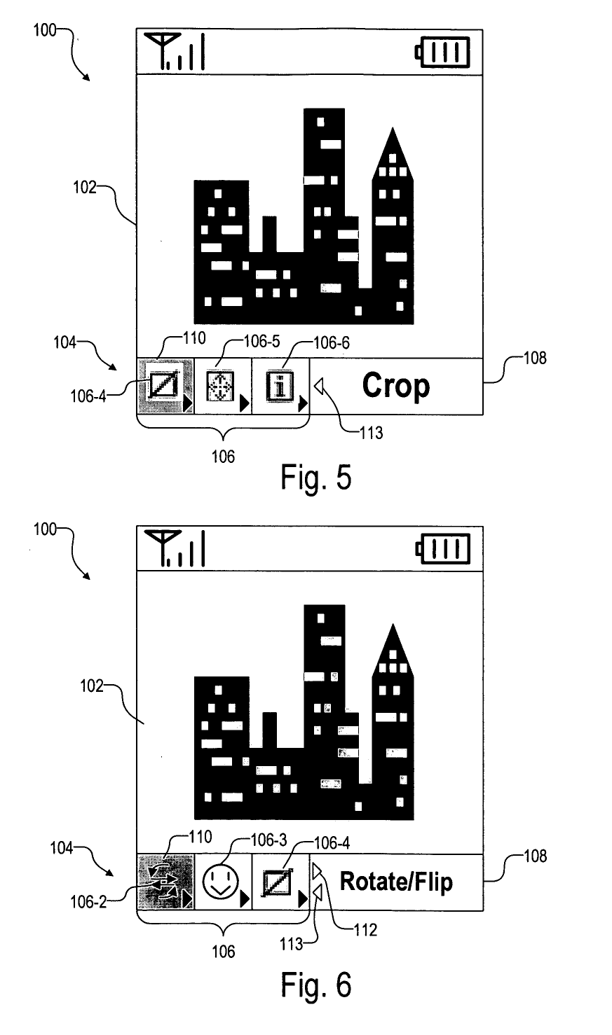

In another embodiment illustrated in FIG. 5, all of the tool icons are removed and new tool icons are added to toolbar area 106 when cursor 110 moves beyond the right-most or the left-most tool icon. For example, when cursor 110 moves to the right beyond tool icons 106-3, tool icons 106-1, 106-2, and 106-3 shift to the left so that they are all removed and new tool icons 106-4, 106-5, and 106-6 (e.g., icons for crop, full screen, and information) are added to toolbar area 106. Note that cursor 110 now identifies tool icon 106-4. Further note that in FIG. 5, indicator 113 visually tells the user that toolbar 104 has additional tools to the left of the current tool icons.

In another embodiment illustrated in FIG. 6, one of the previously displayed tool icons is removed and a new tool icon is added to toolbar area 106 when cursor 110 moves beyond a set tool icon (e.g., the first tool icon). For example, when cursor 110 moves to the right of tool icons 106-1, tool icons 106-1, 106-2, and 106-3 shift to the left so that tool icon 106-1 is removed and a new tool icon 106-4 is added to toolbar area 106. Note that cursor 110 now identifies tool icon 106-2.

Various other adaptations and combinations of features of the embodiments disclosed are within the scope of the invention. For example, the number of displayed icons in toolbar area 106 can vary between embodiments. Furthermore, the way in which the tool icon is selected can be varied. For example, two graphics for the same icon, one for “unselected” and the other for “selected” may be used. Numerous embodiments are encompassed by the following claims.

What is claimed is:

1. A toolbar, comprising:
a first toolbar area, comprising:
a plurality of icons;
a cursor visually identifying one of the icons, wherein when a user moves the cursor beyond a position, the icons shift so that at least one of the icons is removed and at least one new icon is added;
a second toolbar area displaying information about the icon identified by the cursor.

2. The toolbar of claim 1, wherein when the user moves the cursor beyond an icon located at a first end of the first toolbar area, an icon located at a second end of the first toolbar area is removed, the remaining icons are shifted toward the second end, and the new icon is added to the first end.

3. The toolbar of claim 1, wherein when the user moves the cursor beyond an icon located at one end of the first toolbar area, the icons are removed and a plurality of new icon are added.

4. The toolbar of claim 1, wherein when the user moves the cursor beyond an icon, the icon is removed, the remaining icons are shifted away from a direction of a cursor movement, and the new icon is added to the first toolbar area.

5. The toolbar of claim 1, wherein the cursor comprises a highlighted area around an icon.

6. A method for displaying a toolbar, comprising:
generating a first toolbar area, comprising:
a plurality of icons;
a cursor visually identifying one of the icons;
generating a second toolbar area displaying information about the icon identified by the cursor;
in response to a user moving the cursor beyond a position, shifting the icons so that at least one of the icons is removed and at least one new icon is added.

7. The method of claim 6, wherein the cursor is moved beyond the position when the user moves the cursor beyond an icon located at a first end of the first toolbar area, said shifting comprising removing an icon located at a second end of the first toolbar area, shifting remaining icons toward the second end, and adding the new icon to the first end.

8. The method of claim 6, wherein the cursor is moved beyond the position when the user moves the cursor beyond an icon located at one end of the first toolbar area, said shifting comprising removing the icons and adding a plurality of new icon.

9. The method of claim 6, wherein the cursor is moved beyond the position when the user moves the cursor beyond an icon, said shifting comprising removing the icon located, shifting remaining icons away from a direction of a cursor movement, and adding the first toolbar area.

10. The method of claim 6, wherein the cursor comprises a highlighted area around an icon.
